(19) United States
(12) Patent Application Publication
(10) Pub. No.: US 2009/0053499 A1
(43) Pub. Date: Feb. 26, 2009

(54) Covering for Compost

(76) Inventor: Nelson G. Wong, Fallston, MD (US)

Correspondence Address: Nelson G. Wong, 2205 Watervale Rd., Fallston, MD, 21047, US

(21) Appl. No.: 11/837,541

(22) Filed: Aug. 20, 2007

(51) Int. Cl. B32B 33/00

(52) U.S. Cl. 428/221

(57) ABSTRACT

The invention is a covering for compost to accelerate the composting process. The invention improves upon the current covering methods by providing an all-in-one solution that retains warmth, provides for evaporation of excessive moisture, and allows air convection to provide an ideal environment for microorganism activities.

### BACKGROUND

In the making of compost from garden, yard, kitchen, and other organic waste materials, composting microorganisms are most active in warm temperature environments with sufficient air and moisture. Moisture, air, and temperature balances are important. Lack of air will prevent microorganism activities. Low temperatures slow activities. Excessively high temperatures, whether internally generated or from outside, can stop activities. Dry conditions could cause microorganism deactivations. Overly damp conditions result in fermentation.

There are many methods used to reduce the composting time from the months or years in nature to a few weeks through optimization attempts on the heat, air, and moisture components.

Simple methods employed include placement of materials in hand-made or ready-made covered bins or simply piling material on the ground to expedite composting. Bins or containments may be enhanced with ventilation provisions and heat and moisture retaining features such as dark retaining material to absorb solar heat on sunny days, insulated sides to retain heat, and a lid for protection against rain. The compost material is regularly turned to incorporate air and moisture and moderate temperature extremes. However, moisture and heat would still be lost.

Coverings would be employed to further minimize moisture or heat loss. Whatever suitable material is on hand, such as plastic sheets, tarps, and other sheeting, would be used. In commercial operations, geotextile sheets are laid over piles or windrows of compost. Use of coverings may result in water condensation underneath that creates an overly damp condition. Solutions would be venting commonly in the way of perforations. Blankets, carpet, and other material with insulating properties may be employed to retain heat. If kept in place too long without ventilation, excessive heat can build up.

The invention improves upon the current covering methods by providing an all-in-one solution that retains warmth, provides for evaporation of excessive moisture, and allows air convection to provide an ideal environment for microorganism activities. No patents or applications were found for this type of covering.

Specification:

The invention consists of an outer fabric that encloses an insulated core. All components will be made of mildew-resistant synthetic material. The materials may also have moisture-wicking properties.

The outer fabric will consist of a highly UV-resistant, air and moisture-permeable, water-resistant or waterproof, synthetic fabric. Polypropylene and polyester are common outdoor materials used.

The core will be composed of synthetic fibers that are designed to restrict heat passage. One such material is hollow polyester fiber that relies on a hollow-core air pocket in the filaments to trap heat.

The outer fabric porosity will be such to restrict compost debris penetration that could clog the air pockets in the core fiber filaments.

The fibers will be spaced to allow sufficient air flow for aeration and the drawing out of moisture to be evaporated.

The natural air obstruction of a covering will be relied upon to ensure that not too much moisture escapes to cause excessive drying.

### DESCRIPTION OF THE DRAWINGS

FIG. 1 shows the invention construction.

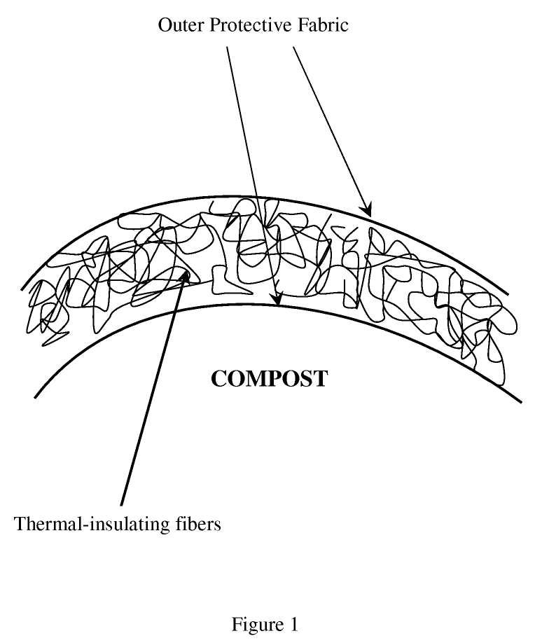

I claim:

1. A covering for composting comprised of an outer protective fabric enclosing an insulating core.
a. Outer fabric consisting of a ultra-violet (UV) resistant, air and moisture-permeable, synthetic fabric.
b. Core comprised of thermal-insulating synthetic fibers spaced for air flow.
